(19) United States
(12) Patent Application Publication
(10) Pub. No.: US 2024/0348194 A1
(43) Pub. Date: Oct. 17, 2024

(54) SOLAR CANOPY SYSTEM

(71) Applicant: Pavilion Solar USA, Inc, Biscayne Park, FL (US)

(72) Inventor: Aleksandr Bernhard, Biscayne Park, FL (US)

(21) Appl. No.: 18/634,629

(22) Filed: Apr. 12, 2024

Related U.S. Application Data
(60) Provisional application No. 63/495,684, filed on Apr. 12, 2023.

(51) Int. Cl. H02S 20/24; E04F 10/00; H02S 10/20

(52) U.S. Cl. CPC H02S 20/24; E04F 10/005; H02S 10/20

(57) ABSTRACT

A system includes: a canopy assembly and a power distribution system. The canopy assembly includes: a set of support columns; a set of perimeter elements; a set of joists; and a set of joints. The set of support columns are configured to couple to a foundation. The set of perimeter elements are arranged in a rectangular geometry. The set of corner joints are arranged at corner intersections of the set of perimeter elements. Each corner joint includes a set of tenon members configured to interlock with the set of perimeter elements and the set of support columns to couple the canopy assembly to the foundation. The power distribution system includes: a set of solar panels coupled to the set of joists; and a power inverter(s) coupled to the set of solar panels and configured to transfer energy from the set of solar panels to an electrical system.

### CROSS-REFERENCE TO RELATED APPLICATIONS

This Application claims the benefit of U.S. Provisional Application No. 63,495,684, filed on 12 Apr. 2023, which is hereby incorporated in its entirety by this reference.

### TECHNICAL FIELD

This invention relates generally to the field of solar energy systems and more specifically to a new and useful solar canopy system with integrated solar panels in the field of solar energy systems.

### BRIEF DESCRIPTION OF THE FIGURES

FIG. 1 is a schematic representation of a solar canopy system;

FIG. 2 is a schematic representation of the solar canopy system;

FIG. 3 is a schematic representation of the solar canopy system;

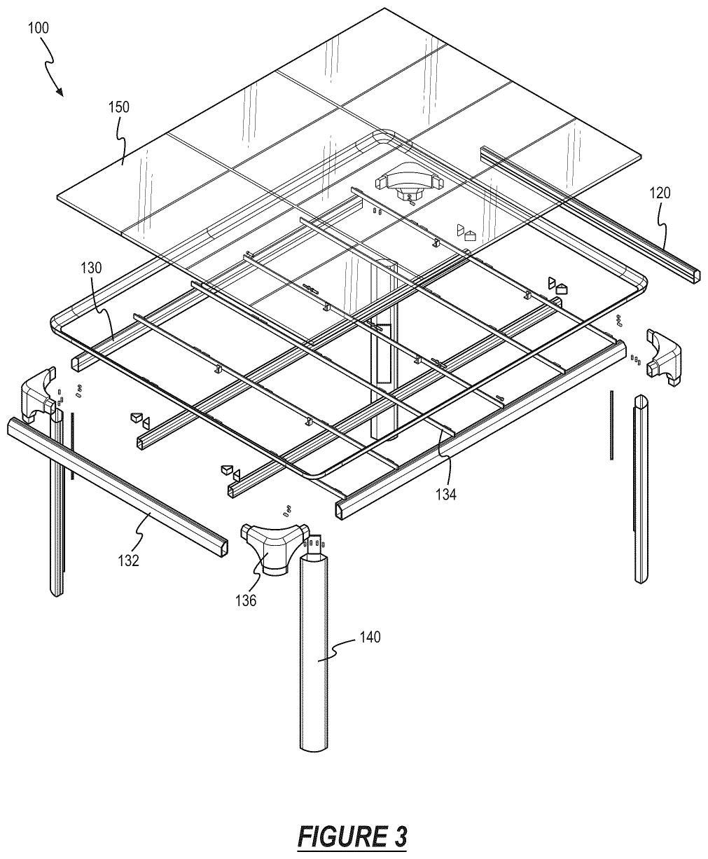

FIG. 4 is a schematic representation of the solar canopy system;

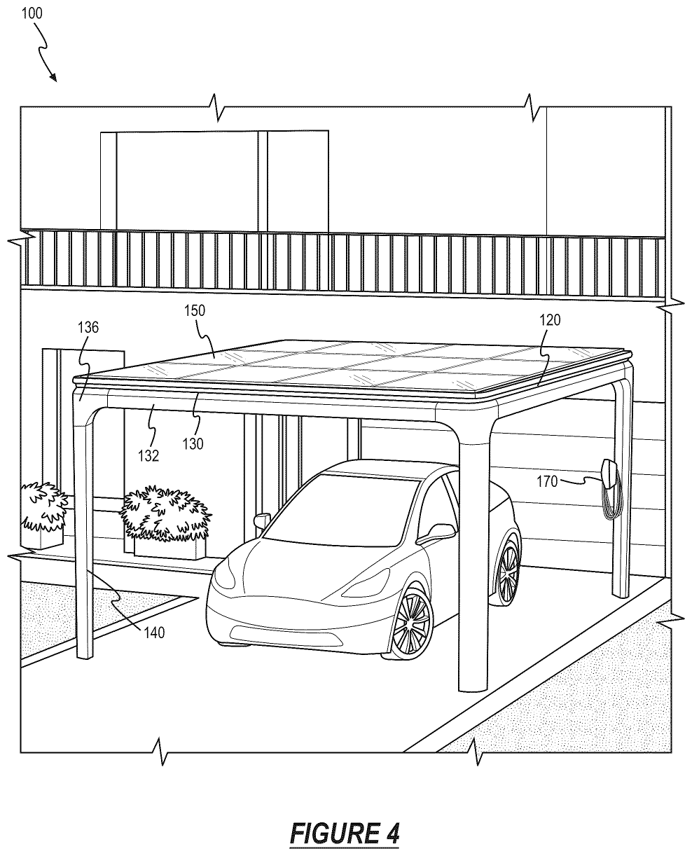

FIG. 5 is a schematic representation of the solar canopy system; and

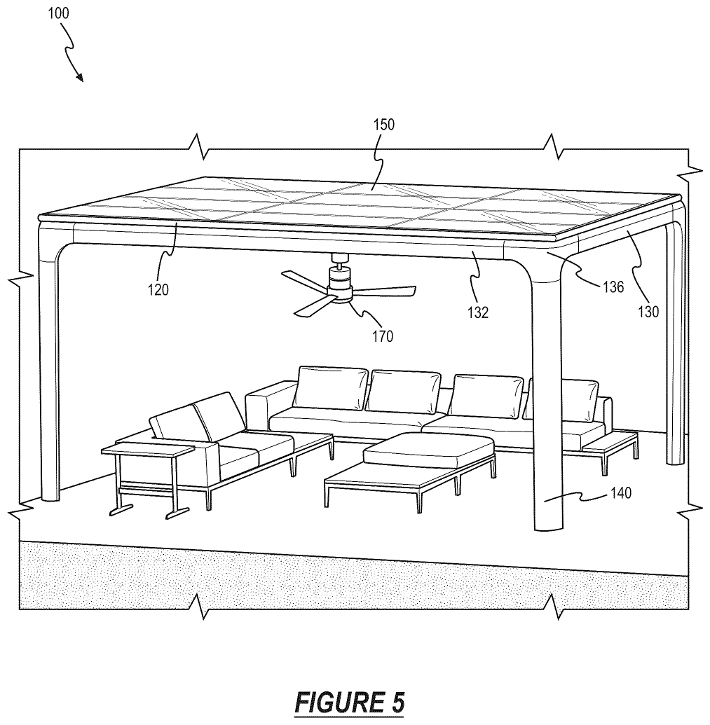

FIG. 6 is a schematic representation of the solar canopy system.

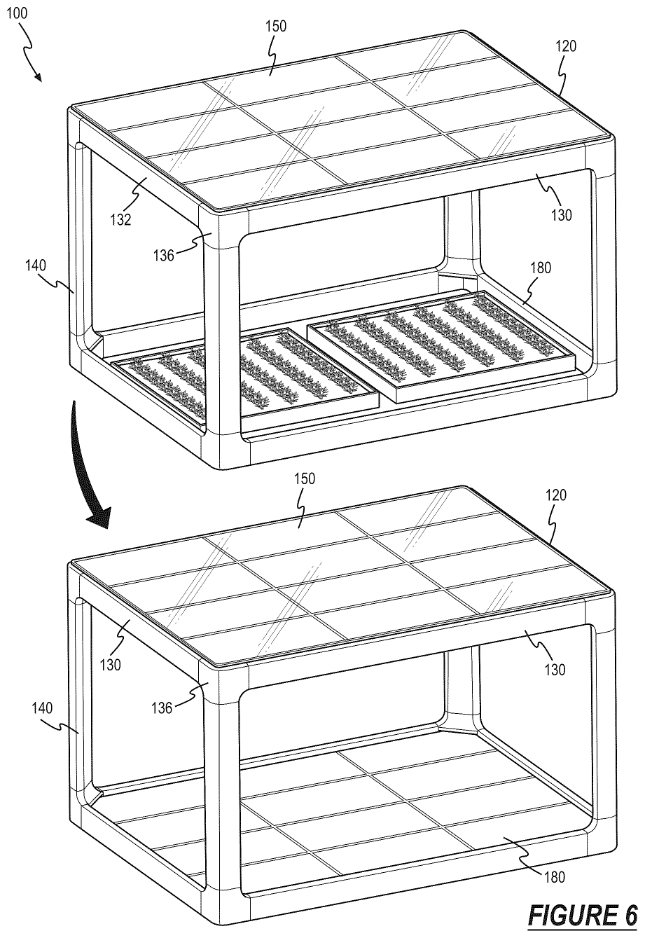

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System

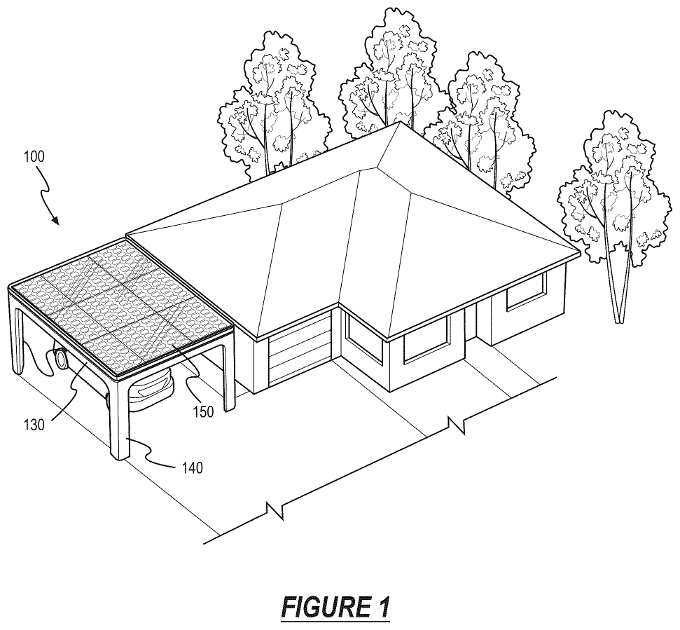

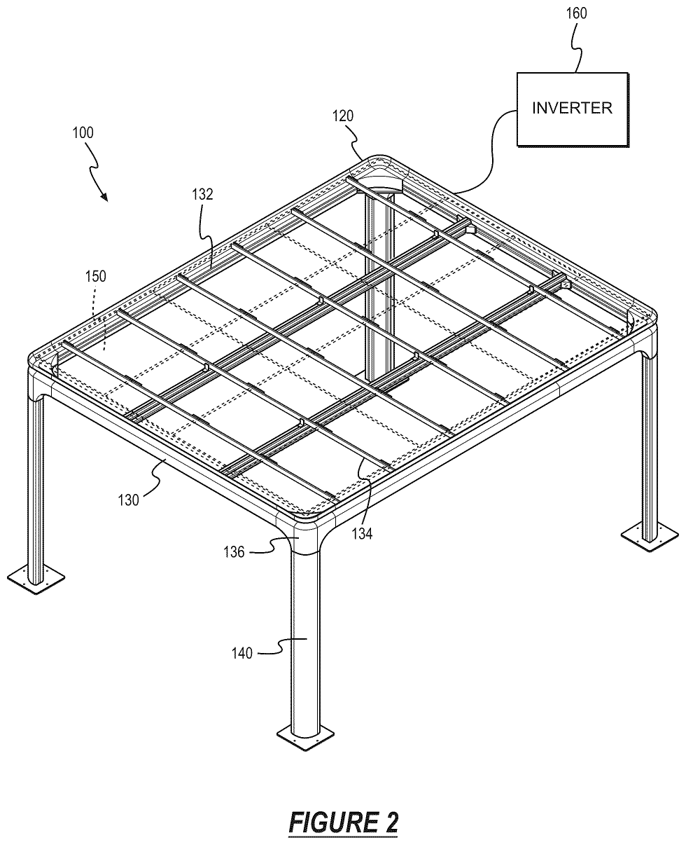

As shown in FIGS. 1 and 2, a solar canopy system 100 (hereinafter “system 100”) includes: a canopy assembly 120; a power distribution system 160; and a set of accessories 170 (e.g., power outlets, lighting modules, electrical appliances).

The canopy assembly 120 includes: a set of support columns 140 configured to couple to a foundation (e.g., concrete foundation, screw piles) of a designated assembly site (e.g., residential home, commercial venue); and a roofing frame 130.

The roofing frame 130 includes: a set of perimeter elements 132 (e.g., aluminum beams) arranged in a rectangular geometry; a set of joists 134 (e.g., rails) coupled to the set of perimeter elements 132 and contained within the rectangular geometry; and a set of corner joints 136 supported by the set of support columns 140 and arranged at corner intersections of the set of perimeter elements 132.

Each corner joint, in the set of corner joints 136 includes: a corner section; a first tenon member extending from a first side of the corner section and configured to mate within a first inner channel of a first perimeter element, in the set of perimeter elements 132; a second tenon member, arranged orthogonal to the first tenon member, extending from a second side of the corner section and configured to mate within a second inner channel of a second perimeter element, in the set of perimeter elements 132; and a third tenon member, arranged orthogonal to the first tenon member and the second tenon member, extending from a bottom side of the corner section and configured to mate within a third inner channel of a support column, in the set of support columns 140.

The power distribution system 160 includes: a set of solar panels 150 coupled to the set of joists 134 of the roofing frame 130; and a power inverter(s) (e.g., microinverter, solar inverter) electrically coupled to the set of solar panels 150 and configured to transfer electrical energy generated from the set of solar panels 150 to an electrical power system.

The set of accessories 170 are electrically coupled to the power distribution system 160 and includes: a power outlet (e.g., 120-Volt outlet) configured to locate on a support column, in the set of support columns 140, of the canopy assembly 120; a set of lighting modules arranged across a periphery of the roofing frame 130; a kitchen appliance (e.g., electric stove) configured to locate on a flooring area within the canopy assembly 120; a television mount configured to locate at a perimeter element, in the set of perimeter elements, of the canopy assembly 120; an electric vehicle charger (e.g., level 2 charger) configured to locate on the support column, in the set of support columns 140, of the canopy assembly 120; a ceiling fan configured to locate on the roofing frame 130 of the canopy assembly 120.

### 2. Applications

Generally, the system 100 forms a freestanding, stand-alone canopy (or “pavilion”) structure that can be readily assembled without need for specialized construction equipment (e.g., augers, concrete mixers, scaffolding) at a designated site—such as at a residential home (e.g., single family home, multi-family home), event location, park, urban plaza, sports field, educational campus, and/or a hospitality venue. The system 100 includes a power distribution system 160—such as an array of solar panels 150 (e.g., bifacial solar panels) coupled to a power inverter(s) (e.g., solar inverter, microinverter)—configured to capture, store, and/or supply electrical energy to a suite of accessories 170 (e.g., lighting modules, cooling fans, power outlets, television stands, cooking appliances, speakers, electric vehicle chargers) coupled to and/or integrated into the canopy structure.

More specifically, the system 100 can include: a canopy assembly 120 including a roofing frame 130 and a set of support columns 140 (e.g., aluminum support columns) configured to couple to a foundation in order to vertically support the roofing frame 130 over a designated flooring area; and an array of solar panels 150 (e.g., bifacial solar panels) arranged on the roofing frame 130 and configured to electrically couple an electrical power system (e.g., an electrical grid, power bank). The roofing frame 130 can include: a set of perimeter elements 132 (e.g., aluminum beams) arranged in a rectangular geometry; and a set of joints 136 (e.g., T-shaped corner connector) arranged at corner intersections of the set of perimeter elements 132. The set of support columns 140: is coupled to the set of joints 136 of the roofing frame 130; and is coupled to a set of anchors arranged at a foundation (e.g., concrete foundation, screw piles) in order to vertically support the roofing frame 130 over a flooring area at the designated location for the canopy structure.

In one example, each joint—in the set of joints 136—defines a three-way, T-shaped corner connector, configured to interface (e.g., couple) with a set of perimeter elements 132 of the roofing frame 130 and a support column supporting the roofing frame 130. In particular, the joint can include: a corner section; a first tenon member extending from a first side of the corner section and configured to receive a first inner channel of a first perimeter element (e.g., eighteen-foot aluminum beam), in the set of perimeter elements 132, of the roofing frame 130; a second tenon member, arranged orthogonal to the first tenon member, extending from a second side of the corner section and configured to receive a second inner channel of a second perimeter element (e.g., fourteen-foot aluminum beam), in the set of perimeter elements 132, of the roofing frame 130; and a third tenon member, arranged orthogonal to the first tenon member and the second tenon member, extending from a bottom side of the corner section and configured to receive a third inner channel of a support column (e.g., ten-foot vertical aluminum support column) in the set of support columns 140 coupled to the foundation. This assembly process can then be repeated across corner intersections of the canopy structure to enable structural integrity of the canopy structure at the designated installation location without the need for specialized construction equipment.

Additionally, the roofing frame 130 can include: an intermediate support element (e.g., aluminum beam) extending within the rectangular geometry formed by the set of perimeter elements 132; and a set of joists 134 (e.g., rails) coupled to the intermediate support element and the set of perimeter elements 132 to form a trellis roofing structure configured to support the array of solar panels 150 on the roofing frame 130. Accordingly, the set of joists 134 can include a set of clamps (e.g., end clamps) configured to transiently retain the array of solar panels 150 across the roofing frame 130 and thus, over the flooring area at the designated location. Furthermore, the system 100 can include: a power inverter(s) (e.g., solar inverter, microinverter) arranged externally from the canopy structure (e.g., arranged at a residential home) and/or internally within the canopy structure (e.g., within a support columns 140 of the canopy assembly 120) coupling the array of solar panels 150 to an electrical power system (e.g., residential power grid, power bank); and a power supply coupled to the power inverter(s) (e.g., solar inverter, microinverter) and configured to distribute electrical power from the electrical power system (e.g., residential power grid, power bank) across the suite of accessories 170 (e.g., 120-Volt power outlets, lighting modules, kitchen appliances) coupled to and/or integrated into the canopy structure.

Therefore, the system 100 can concurrently distribute electrical power from the electrical power system (e.g., residential power grid, power bank) to the suite of accessories 170 while offsetting electrical power drawn from the electrical power system with electrical energy generated across the array of solar panels 150.

### 2.1 Applications: Integrated Foundation

In one variation, rather than mounting the canopy assembly 120 to a pre-set foundation (e.g., concrete foundation, screw piles) at a designated location (e.g., residential home, hospitality venue), the system 100 can include an integrated self-ballasting system functioning as an integrated foundation 180 coupling the canopy assembly 120 and configured to enable structural integrity of the canopy assembly 120 at the designated location. The integrated foundation 180 can include a foundation frame including: a second set of perimeter elements (e.g., aluminum beams) defining a rectangular geometry matching the rectangular geometry of the roofing frame 130; and a second set of joints arranged at corner intersections of the set of perimeter elements 132 and coupling the set of support columns 140—coupled to the roofing frame 130 of the canopy assembly 120—to locate the canopy assembly 120 over a flooring area across the foundation frame.

The foundation can further include: a set of weighted media (e.g., sand, water ballasts, steel plates) arranged within the foundation frame proximal the second set of joints; a set of battery cells coupled to the array of solar panels 150 (e.g., via the power inverter(s)) and arranged within the foundation frame; and a set of floor boards arranged across the foundation frame and configured to enclose the set of weighted media and the set of battery cells within the foundation frame. Accordingly, the set of weighted media (e.g., sand, water ballasts, steel plates) and the set of battery cells arranged within the foundation frame enable structural integrity of the canopy assembly 120 from exposure to external environmental conditions (e.g., high-speed winds, rain, hail). As described above, the system 100 can further include a suite of accessories 170 (e.g., lighting modules, power outlets, ceiling fans, kitchen appliances) coupled to the set of battery cells arranged within the foundation frame.

Therefore, rather than receiving power from an external power grid (e.g., residential power grid), the system 100 can concurrently distribute electrical power from the set of battery cells arranged within the integrated foundation 180 to the suite of accessories 170 while offsetting electrical power drawn from the set of battery cells with electrical energy generated across the array of solar panels 150.

### 3. Canopy Assembly

Generally, the system 100 includes a canopy assembly 120 including: a roofing frame 130 (e.g., rectangular frame) configured to support an array of solar panels 150 (e.g., bifacial solar panels 150); and a set of support columns 140 (e.g., aluminum support columns) coupling the roofing frame 130 to a foundation (e.g., concrete foundation, integrated foundation 180) to vertically support the roofing frame 130 over a flooring area (e.g., canopy floor). More specifically, the roofing frame 130 includes: a set of perimeter elements 132 (e.g., aluminum horizontal beams 132) defining a periphery of the roofing frame 130; and a set of joints 136 (e.g., T-shaped corner joints 136) coupling the set of perimeter elements 132 to form a rectangular geometry of the roofing frame 130 and coupling the set of support columns 140 in order to elevate the roofing frame 130 over the flooring area (e.g., flooring area of a foundation). Thus, the system 100 can form a canopy structure including integrated solar panels 150 that can be readily assembled, such as at a residential home (e.g., single family home, multi-family home), event location, parks, urban plaza, sports field, educational campus, and/or hospitality venue.

### 3.1 Roofing Frame

In one implementation, the roofing frame 130 includes: a first subset of perimeter elements, in the set of perimeter elements 132 (e.g., aluminum beams), extending a first length (e.g., eighteen feet); a second subset of perimeter elements, in the set of perimeter elements 132 (e.g., aluminum beams), extending a second length (e.g., fourteen feet), less than the first length, and arranged orthogonal to the first set of perimeter elements 132 to define a rectangular geometry; and a set of joints 136 (e.g., four joints 136) arranged at corner intersections of the first set of perimeter elements 132 and the second set of perimeter elements to rigidly maintain the rectangular geometry of the roofing frame 130.

In one example, each joint—in the set of joints 136—defines a three-way, T-shaped corner connector, configured to interface (e.g., couple) a set of perimeter elements 132 of the roofing frame 130 and a support column supporting the roofing frame 130. More specifically, the joint can include: a corner section; a first tenon member extending from a first side of the corner section; a second tenon member, orthogonal to the first tenon member, extending from a second side of the corner section; and a third tenon member, orthogonal to the first tenon member and the second tenon member, extending from a bottom side of the corner section. In this example, each beam—in the set of perimeter elements 132 of the roofing frame 130—includes an inner channel extending within the perimeter element configured to receive the tenon members extending from the joint. Similarly, each support column—in the set of support columns 140 configured to elevate the roofing frame 130—includes an inner channel extending within the support column configured to receive the tenon members extending from the joint.

Thus, during assembly of the roofing frame 130: the first tenon member receives a first inner channel of a first perimeter element of the roofing frame 130; the second tenon member receives a second inner channel of a second perimeter element in the roofing frame 130 to locate the second perimeter element orthogonal to the first perimeter element of the roofing frame 130; and the third tenon member receives a third inner channel of a first support column, in the set of support columns 140, to locate the support column-extending downward from the joint—orthogonal to the first perimeter element and the second perimeter element. This assembly process can then be repeated for each corner of the roofing frame 130 (e.g., four corners for a rectangular frame) thereby forming a roofing structure (e.g., rectangular roofing structure) elevated by the set of support columns 140. In this example, the system 100 can further include a set of fasteners configured to couple the perimeter elements 132 of the roofing frame 130 to the tenon members of the joint and couple the support column to the tenon members of the joint.

In one implementation, the roofing frame 130 can further include an intermediate support element: arranged parallel to the first subset of perimeter elements, in the set of perimeter elements 132; arranged orthogonal to the second subset of perimeter elements, in the set of perimeter elements 132; and contained within the rectangular geometry defined by the first set of perimeter elements 132 and the second set of perimeter elements. In this implementation, the intermediate support element can further include an intermediate support element channel: inset from an outer facet of the intermediate support element; and extending across the length of the intermediate support element. Accordingly, the intermediate support element can include an intermediate support element channel across each facet (e.g., four sides) of the intermediate support element. Additionally, the second set of perimeter elements can include a first perimeter element: arranged orthogonal to a first distal end of the intermediate support element; and including a first channel orthogonally aligned to the intermediate support element channel of the intermediate support element. Similarly, the second set of perimeter elements can include a second perimeter element: opposite the first perimeter element; arranged orthogonal to a proximal end of the intermediate support element; and including a second channel orthogonally aligned to the intermediate support element channel of the intermediate support element.

The system 100 can further include a first wedge: arranged at an orthogonal intersection between the first perimeter element and the intermediate support element; mating with the intermediate support element channel of the intermediate support element and the first channel of the first perimeter element; and configured to rigidly couple the intermediate support element to the first perimeter element. Similarly, the system 100 can further include a second wedge: arranged at an orthogonal intersection between the second perimeter element and the intermediate support element; mating the intermediate support element channel of the intermediate support element and the second channel of the second perimeter element; and configured to rigidly couple the intermediate support element to the second perimeter element. The system 100 can also include additional wedges to further support orthogonal coupling of the intermediate support element interposed between the first set of perimeter elements 132 of the roofing frame 130.

Therefore, rather than fabrication of a rigidly assembled canopy, the system 100 includes a canopy assembly 120 including a roofing frame 130 and a set of support columns 140 that can be readily assembled, such as at a residential home (e.g., single family home, multi-family home), event location, park, urban plaza, sports field, educational campus, and/or hospitality venue etc.

### 3.2 Trellis Top+Solar Panel Installation

In one implementation, the roofing frame 130 can further include a set of joists 134 (e.g., aluminum rails): arranged in parallel to each other; arranged within the rectangular frame formed by the set of perimeter elements 132 and the set of joints 136; and cooperating with one or more intermediate support elements of the roofing frame 130 to form a trellis structure configured to support an array of solar panels 150. In this implementation, the set of joists 134: are arranged orthogonal to the intermediate support element of the roofing frame 130; are coupled to the intermediate support element, such as via an L-shaped bracket coupling the joist to the intermediate support element; and include a set of clamps (e.g., hidden end clamps) configured to couple the array of solar panels 150 in order to locate the array of solar panels 150 within the rectangular geometry of the roofing frame 130. Therefore, rather than rigidly integrating an array of solar panels 150 within a roofing frame 130, the system 100 includes a roofing frame 130 including a set of joists 134 (e.g., aluminum rails) forming a trellis roofing structure configured to transiently couple an array of solar panels 150.

Additionally, the system 100 can include a skirt (aluminum skirt, thermoplastic skirt): arranged about the periphery of the roofing frame 130; and configured to encompass the array of solar panels 150 contained within the rectangular geometry of the roofing frame 130 in order to block debris (e.g., rain, dust) from entering the roofing frame 130.

### 3.3 Support Columns

In one implementation, the canopy assembly 120 includes a set (e.g., four) of support columns 140 (e.g., aluminum support columns): coupled to a foundation, such as a concrete slab foundation, pier foundations, concrete pads, screw piles, raft foundation; and coupled to the roofing frame 130 in order to vertically support the roofing frame 130 over a flooring area at a target height (e.g., ten feet). As described above, each support column—in the set of support columns 140—is configured to receive a tenon member of the set of joints 136 thereby locating the set of support columns 140 at corner intersections of the roofing frame 130. In one example, each support column—in the set of support columns 140—can include a baseplate defining a substantially flat structure (e.g., aluminum plate) configured to couple a set of anchor bolts of the foundation in order to form a rigid interface coupling the canopy assembly 120 to the foundation. Additionally, each support column—in the set of support columns 140—can define a semi-circular vertical support: defining a curved section aligned to a curvature of an edge of the rectangular frame; and a flat section facing an interior area of the canopy assembly 120.

Therefore, the canopy assembly 120 can include a set of support columns 140: vertically supporting a roofing frame 130; and configured to selectively couple to a foundation thereby allowing for flexible installation of the canopy structure, such as at a residential home, event location, park, urban plaza, sports field, educational campus, and/or hospitality venue etc.

### 4. Solar Panels

In one implementation, the canopy assembly 120 includes an array of solar panels 150 (e.g., bifacial solar panels 150): arranged across the roofing frame 130; defining a roof structure configured to provide shade from sunlight and block debris (e.g., rain) across a flooring area; and electrically coupled to an external electrical system 100 (e.g., electrical grid of a residential home, external battery bank) and/or an integrated power system (e.g., battery bank) at the canopy assembly 120.

In one example, the array of solar panels 150: is electrically coupled (e.g., coupled in series, coupled in parallel) across the roofing frame 130; and includes a set of leads (e.g., positive, negative leads) extending within the roofing frame 130 and the set of support columns 140. In particular, the array of solar panels 150 can include a set of leads: extending internally within a perimeter element of the roofing frame 130; extending internally within a joint of the roofing frame 130; and extending internally within a support column vertically supporting the roofing frame 130. The system 100 can then include a solar inverter(s)—such as a set of microinverters coupled to the canopy assembly 120 (e.g., within beams 132, support columns 140, joints 136) or arranged externally from the canopy assembly 120—configured to electrically couple the array of solar panels 150 (e.g., via the set of leads) to a grid-tie interface (e.g., residential power grid interface, power bank interface). Thus, electrical energy generated across the array of solar panels 150—arranged on the canopy assembly 120—can be transferred to an electrical network, such as a residential power grid and/or a battery bank.

In another example, the array of solar panels 150 can define an array of bifacial solar panels 150 extending across the roofing frame 130. In this example, the roofing frame 130 can further include a reflective canopy (e.g., aluminized mylar, polished aluminum, silvered reflective film, white painted structure) arranged below the array of solar panels 150 on the roofing frame 130. Thus, the array of bifacial solar panels 150 can: receive light energy from a first side (e.g., facing opposite the flooring area); and receive light energy reflected from the reflective canopy at a second side (e.g., facing the flooring area).

Therefore, the system 100 can include an array of solar panels 150: electrically coupled to a grid-tie interface (e.g., residential grid interface, power bank interface); and configured to transfer electrical energy generated across the array of solar panels 150 to an external and/or integrated electrical distribution network (e.g., residential power grid, battery storage system 100).

### 4.1 Canopy Power Supply

In one implementation, the system 100 includes a power supply: electrically coupled to an electrical power grid, such as a grid-tied electrical system 100 for a residential home (e.g., single family home, multi-family home), a battery storage system 100, and/or a generator; and configured to distribute power across a set of electrical outlets (e.g., 120-Volt outlets), such as arranged at beams 132, support columns 140, or joints 136 of the canopy assembly 120.

In one example, the canopy assembly 120 is integrated at a residential home—such as at a driveway of a residential home or a backyard of a residential home—and configured to interface with an electrical grid system 100 of the residential home. In this example, the system 100 includes: a power inverter(s) (e.g., solar inverter, microinverter) arranged externally or internally within the canopy assembly 120 and configured to direct electrical energy generated across the set of solar panels 150 to the electrical grid system 100 of the residential home; and a power supply coupled to the electrical grid system 100 of the residential home and configured to distribute power to a set of outlets (e.g., 120-Volt outlets) at the canopy assembly 120 and/or to installed appliances (e.g., ceiling fans, lighting modules, electric vehicle chargers) arranged at the canopy assembly 120.

Therefore, the system 100 can concurrently: transfer electrical energy generated by the set of solar panels 150 on the canopy assembly 120 to the electrical grid system 100 of the residential home; and distribute power from the electrical grid system 100 to outlets and/or appliances arranged at the canopy assembly 120 while offsetting energy demand from the electrical grid system 100 to the canopy assembly 120.

In another example, the canopy assembly 120: is integrated at a location that is isolated from a power grid (e.g., park, sports field, hospitality venue); and configured to interface with a stand-alone electrical power system (e.g., generator, battery bank) in order to distribute electrical power across a set of outlets (e.g., 120-Volt outlets) and/or appliances (e.g., lighting modules, fans, car chargers) at the canopy assembly 120. In this example, the system 100 can include: a power bank (e.g., battery cells)—such as integrated internally or externally within the canopy assembly 120—configured to distribute electrical power to the set of outlets and/or appliances at the canopy assembly 120; and a power inverter(s) (e.g., solar inverter, microinverter) arranged externally or internally within the canopy assembly 120 and configured to direct electrical energy generated across the set of solar panels 150 to the power bank and thus, store electrical energy within battery cells of the power bank.

Therefore, the system 100 can concurrently: transfer electrical energy generated by the set of solar panels 150 on the canopy assembly 120 to the power bank to reserve electrical power; and distribute electrical power from the power bank to outlets and/or appliances arranged at the canopy assembly 120 while offsetting energy demand from the power bank to the canopy assembly 120.

### 5. Foundation

Generally, the system 100 includes a foundation (e.g., concrete foundation, screw piles) configured to enable structural integrity of the canopy assembly 120.

In one implementation, the system 100 includes a set of anchors arranged across a continuous foundation (e.g., concrete foundation), such as arranged at a driveway of a residential home or a poured-concrete foundation at a backyard of a residential home. In this implementation, as described above, each support column—in the set of support columns 140 vertically supporting the roofing frame 130—can include a baseplate configured to couple the set of anchors and thereby enable structural integrity of the canopy assembly 120 assembled at the foundation.

In another implementation, the system 100 can include a set of foundation elements (e.g., screw piles, stone bases) configured to couple the set of support columns 140 in order to enable structural integrity of the canopy assembly 120. For example, the system 100 can include a set (e.g., four) screw piles anchored to a ground surface (e.g., backyard of a residential home). In this example, as described above, each support column—in the set of support columns 140 vertically supporting the roofing frame 130—can include the baseplate configured to couple the set of foundation elements (i.e., the screw piles)-in order to enable structural integrity of the canopy assembly 120 over the ground surface.

### 5.1 Integrated Foundation

In one implementation, rather than securing the canopy assembly 120 to an existing foundation, such as a concrete foundation and/or screw pile foundation, the system 100 can include a stand-alone, self-ballasting integrated foundation 180 (e.g., weighted foundation) to structurally support the canopy assembly 120. In this implementation, the system 100 can include: a foundation frame coupling the set of support columns 140 to vertically support the roofing frame 130 over the foundation frame; and weighted media (e.g., steel plates, sand, water ballasts) arranged within the foundation frame and configured to stabilize (e.g., from wind, top soil) the canopy assembly 120 coupled to the foundation frame. As described above for the roofing frame 130, the foundation frame can similarly form a rectangular geometry congruent to the geometry of the roofing frame 130 of the canopy assembly 120.

For example, the foundation frame can include: a set of perimeter elements 132 arranged in a rectangular geometry matching the rectangular geometry of the roofing frame 130; and a set of joints 136 (e.g., T-shaped joints 136) arranged at corner intersections of the set of perimeter elements 132 and coupling the set of support columns 140 to locate the roofing frame 130 over the foundation frame In this example, as described above, each joint—in the set of joints 136—defines a three-way, T-shaped corner connector, configured to interface (e.g., couple) a set of perimeter elements 132 of the roofing frame 130 and a support column supporting the roofing frame 130. Additionally, the system 100 can include: a set of floor boards (e.g., wooden boards, aluminum boards) arranged across the foundation frame and defining a flooring area below the roofing frame 130; and a set of weighted media (e.g., sand bags, water ballasts, steel plates) arranged within the foundation frame and below the set of floor boards in order to enable structural integrity of the canopy assembly 120 from environmental conditions, such as from high-speed winds, hail, and rain. In the aforementioned example, the set of weighted media can be arranged at corner locations of the foundation frame proximal the set of support columns 140 supporting the roofing frame 130.

In another implementation, the foundation frame can further include a set of battery cells arranged below the floor boards of the foundation frame. In one example, the system 100 can include a set of battery cells defining the weighted media arranged within the foundation frame in order to enable structural integrity of the canopy assembly 120. In another example, the system 100 can include a combination of battery cells and weighted media (e.g., sand, water ballasts, steel plates) to enable structural integrity of the canopy assembly 120. In this implementation, the array of solar panels 150 can include a set of leads: extending within a first perimeter element of the roofing frame 130; extending within a first corner joint of the roofing frame 130; extending within a support column coupled to the roofing frame 130; extending within a second corner joint of the foundation frame; and extending within a second perimeter element of the foundation frame in order to electrically couple a power inverter(s) arranged within the foundation frame.

Additionally, the system 100 can include the power inverter(s) coupled to the set of battery cells arranged within the foundation frame in order to transfer electrical energy generated across the array of solar panels 150 across the set of battery cells. Accordingly, the canopy assembly 120 can include a suite of accessories 170 (e.g., lighting modules, fans, television stands, power outlets) coupled to the set of battery cells within the foundation frame.

Therefore, the system 100 can form a stand-alone canopy structure that also functions as a solar-powered generator configured to distribute power to a suite of accessories 170 (e.g., lighting modules, fans, electric vehicle charges, outlets) at the canopy assembly 120. Additionally, the system 100 can include an integrated ballasting system functioning as an integrated foundation 180 that enables flexibility in assembling the canopy assembly 120 at a desired location, such as at a backyard of a residential home, hospitality venue, or a park.

### 6. Canopy Accessories

In one implementation, the system 100 can include a suite of accessories 170—such as lighting modules, cooling fans, power outlets, television stands, cooking appliances, speakers, electric vehicle chargers—integrated into and/or coupled to the canopy assembly 120. More specifically, as described above, the system 100 can include a power supply (e.g., integrated within the canopy assembly 120, external to the canopy assembly 120): coupled to a power grid system 100 (e.g., residential power grid, power bank); and configured to distribute electrical power to the suite of accessories 170 at the canopy assembly 120.

For example, the system 100 can include: a set of power outlets (e.g., 120-Volt outlets) arranged at the set of support columns 140 supporting the roofing frame 130; and a power supply coupled to a power grid (e.g., battery cells, residential power grid, generator) and configured to transfer electrical power to the set of power outlets. Therefore, the system 100 can support installation of electrical appliances (e.g., lighting modules, kitchen appliances) for operation by users within the canopy structure.

### 7. Example: Residential Solar Canopy+Electrical Vehicle Charger

In one example, the system 100 includes: a canopy assembly 120 arranged at a driveway of a residential home; an array of solar panels 150 arranged on the canopy assembly 120 and configured to transfer electrical power generated across the array of solar panels 150 to a power grid of the residential home; and an electric vehicle charger (e.g., level two charger, combined charging system 100)—coupled to the canopy assembly 120 and to the power grid of the residential home—and configured to interface with an electric vehicle at the canopy assembly 120. In this example, the canopy assembly 120 includes: a roofing frame 130, as described above, configured to support the array of solar panels 150; and a set of support columns 140 (e.g., aluminum support columns) configured to couple a set of anchors (e.g., wedge anchors, epoxy anchors, sleeve anchors) arranged across the driveway and enabling structural integrity of the canopy assembly 120.

Accordingly, the array of solar panels 150 includes a set of leads (e.g., positive lead, negative lead) extending within the canopy assembly 120—such as concealed within the perimeter elements 132 of the roofing frame 130 and the set of support columns 140—and coupled to a power inverter(s) (e.g., solar inverter, microinverter) arranged proximal the residential home. Additionally, the power inverter(s) is coupled to a power grid of the residential home thereby transferring electrical power generated across the array of solar panels 150 to the power grid of the residential home.

Additionally, in this example, the system 100 further includes the electric vehicle charger (e.g., level two charger, combined charging system 100): arranged at a support column, in the set of support columns 140, of the canopy assembly 120; and electrically coupled to the power grid of the residential home. Therefore, the system 100 can: form a canopy structure configured to shade an electrical vehicle arranged below the roofing frame 130 of the canopy assembly 120; and include an array of solar panels 150 configured to offset power draw from the power grid of the residential home; and include an electric vehicle charger configured to charge the electric vehicle while offsetting power draw from the power grid of the residential home.

### 8. Example: Stand-Alone Event Solar Canopy

In one example, the system 100 includes: a canopy assembly 120 forming a freestanding, stand-alone canopy structure for an event location (e.g., hospitality venue, park, urban plaza); an integrated foundation 180 including a set of battery cells and configured to enable structural integrity of the canopy assembly 120; an array of solar panels 150 arranged on the canopy assembly 120 and configured to transfer electrical power generated across the array of solar panels 150 to the set of battery cells within the foundation; and a suite of accessories 170 (e.g., ceiling fans, electrical outlets) integrated into and/or coupled to the canopy assembly 120.

In this example, the canopy assembly 120 can include, as described above: a roofing frame 130 configured to support the array of solar panels 150; and a set of support columns 140 (e.g., aluminum support columns) configured to couple the integrated foundation 180. The integrated foundation 180 can include, as described above: a foundation frame coupled to the set of support columns 140 and defining a flooring area below the roofing frame 130; a set of weighted media (e.g., sand, water ballasts, steel plates) arranged within the foundation frame and configured to enable structural integrity of the canopy assembly 120; a power inverter(s) arranged within the foundation frame and coupled to the array of solar panels 150 arranged on the roofing frame 130 of the canopy assembly 120; and the set of battery cells coupled to the power inverter(s) and configured to receive electrical charge from the electrical power generated across the array of solar panels 150.

Additionally, in this example, the system 100 can include: a set of outlets (e.g., 120-Volt outlets) coupled to the set of battery cells and arranged at the set of support columns 140 interposed between the roofing frame 130 of the canopy assembly 120 and the foundation frame; and a ceiling fan coupled to the set of battery cells and coupled to the roofing frame 130 of the canopy assembly 120. Therefore, rather than coupling the system 100 to an external power grid (e.g., residential power grid), the system 100 can: form a stand-alone canopy structure configured to provide shade to users below the roofing frame 130 of the canopy assembly 120; include a foundation including a set of battery cells electrically charged from the power generated across the array of solar panels 150; and include a set of outlets (e.g., 120-Volt outlets) configured to electrically power appliances (e.g., medical equipment, kitchen appliances) operated by the users at the canopy structure.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A system for a solar canopy comprising:
a canopy assembly comprising:
a set of support columns configured to couple to a foundation; and
a roofing frame comprising:
a set of perimeter elements arranged in a rectangular geometry;
a set of joists coupled to the set of perimeter elements and contained within the rectangular geometry; and
a set of corner joints arranged at corner intersections of the set of perimeter elements, each corner joint, in the set of corner joints comprising:
a corner section;
a first tenon member extending from a first side of the corner section and configured to mate within a first inner channel of a first perimeter element, in the set of perimeter elements;
a second tenon member, arranged orthogonal to the first tenon member, extending from a second side of the corner section and configured to mate within a second inner channel of a second perimeter element, in the set of perimeter elements; and
a third tenon member, arranged orthogonal to the first tenon member and the second tenon member, extending from a bottom side of the corner section and configured to mate within a third inner channel of a support column, in the set of support columns; and
a power distribution system comprising:
a set of solar panels coupled to the set of joists of the roofing frame; and
a power inverter electrically coupled to the set of solar panels and configured to transfer electrical energy generated from the set of solar panels to an electrical power system.

2. The system of claim 1, further comprising an integrated foundation:
comprising:
a foundation frame coupled to a bottom end of the set of support columns; and
a set of battery cells:
arranged within the foundation frame; and
coupled to the power inverter, the power inverter configured to transfer electrical energy generated across the set of solar panels to the set of battery cells; and
configured form a self-ballasting structure supporting the canopy assembly.
